(19) United States
(12) Patent Application Publication
(10) Pub. No.: US 2026/0225263 A1
(43) Pub. Date: Aug. 6, 2026

(54) BIOMIMETIC FINGER, GRIPPER, AND MANUFACTURING METHOD OF BIOMIMETIC FINGER

(71) Applicants: THE HONG KONG POLYTECHNIC UNIVERSITY, Hong Kong (CN); SHANGHAI JIAO TONG UNIVERSITY, Shanghai (CN)

(72) Inventors: Yuan MA, Hong Kong (CN); Jing WANG, Shanghai (CN); Xiaodan HU, Hong Kong (CN); Yan Tung CHAN, Hong Kong (CN); Chun Yu KOON, Hong Kong (CN); Cheuk Shing SUM, Hong Kong (CN)

(21) Appl. No.: 19/538,055

(22) Filed: Feb. 12, 2026

Related U.S. Application Data
(63) Continuation of application No. PCT/CN2024/099917, filed on Jun. 18, 2024.

(30) Foreign Application Priority Data
Jun. 27, 2023 (CN) 202310768913.7

(51) Int. Cl. B25J 15/00; B25J 15/08; B25J 19/00

(52) U.S. Cl. CPC B25J 15/0085; B25J 15/08; B25J 19/007

(57) ABSTRACT

The present application provides a biomimetic finger including an epidermis provided with a first liquid outlet hole; an elastomer wrapped and mounted within the epidermis, the elastomer is provided with a second liquid outlet hole, and the second liquid outlet hole is communicated with the first liquid outlet hole; a rigid support member, wrapped and mounted within the epidermis; and a liquid delivery tube, a first end of the liquid delivery tube is wrapped and mounted within the epidermis, the first end of the liquid delivery tube is supported between the rigid support member and the elastomer, a side of the first end of the liquid delivery tube is provided with a third liquid outlet hole, the third liquid outlet hole is communicated with the second liquid outlet hole, and a second end of the liquid delivery tube extends to an outside of the epidermis.

### CROSS REFERENCE TO RELATED APPLICATION

The present application is a continued application of an international application PCT/CN2024/099917, filed on Jun. 18, 2024, and claims priority to Chinese Patent Application No. 202310768913.7, filed with the China National Intellectual Property Administration on Jun. 27, 2023, the entire contents of which are incorporated herein by reference.

### TECHNICAL FIELD

The present application relates to the technical field of biomimetic mechanical technologies, and more particularly to a biomimetic finger, a gripper, and a manufacturing method of a biomimetic finger.

### BACKGROUND

Biomimetic machinery is a cutting-edge technology in modern development, such as biomimetic animals, biomimetic robotic arms, and biomimetic fingers. Currently, the friction force between the biomimetic finger and the grasped object is constant during the grasping process. This leads to problems: if the friction force is too small, the object is easily slipped; if the friction force is too large, the object is easily crushed or deformed, preventing the use of appropriate force to grasp the object.

Therefore, existing biomimetic fingers suffer from the technical problem of non-adjustable friction force.

### SUMMARY

The objective of the present application is to provide a biomimetic finger, a gripper, and a manufacturing method of a biomimetic finger, aiming to solve the technical problem of non-adjustable friction force in existing biomimetic fingers.

In a first aspect, the present application provides a biomimetic finger, which includes:
an epidermis, provided with a first liquid outlet hole;
an elastomer, wrapped and mounted within the epidermis, the elastomer is provided with a second liquid outlet hole, and the second liquid outlet hole is communicated with the first liquid outlet hole;
a rigid support member, wrapped and mounted within the epidermis; and
a liquid delivery tube, a first end of the liquid delivery tube is wrapped and mounted within the epidermis, the first end of the liquid delivery tube is supported between the rigid support member and the elastomer, a side of the first end of the liquid delivery tube is provided with a third liquid outlet hole, the third liquid outlet hole is communicated with the second liquid outlet hole, and a second end of the liquid delivery tube extends to an outside of the epidermis.

In a second aspect, the present application provides a gripper, which includes an closing and opening driving member and at least two biomimetic fingers as described in any of the preceding aspects. The closing and opening driving member is connected to the biomimetic fingers to drive at least two of the biomimetic fingers to move closer to or further away from each other.

In a third aspect, the present application provides a manufacturing method of the biomimetic finger as described above, the manufacturing method includes the following steps:
providing an epidermis provided with a first liquid outlet hole;
mounting an elastomer on a surface of the epidermis, the elastomer encloses at least a part of the first liquid outlet hole;
mounting a first end of a liquid delivery tube on a side of the elastomer away from the epidermis, and locating a second end of the liquid delivery tube outside the epidermis;
mounting a rigid support member on the liquid delivery tube; and
folding the epidermis so that the epidermis wraps the elastomer, the first end of the liquid delivery tube, and the rigid support member.

The beneficial effects of the biomimetic finger, the gripper, and the manufacturing method of the biomimetic finger provided in the present application are: when the epidermis of the biomimetic finger contacts the grasped object, polar liquids or non-polar liquids such as artificial sweat, pure water, saline solution, or oil can flow from the second end of the liquid delivery tube located outside the epidermis to the first end of the liquid delivery tube located inside the epidermis, and then sequentially through the third liquid outlet hole, the second liquid outlet hole, and the first liquid outlet hole to the space between the epidermis and the grasped object, changing the friction coefficient between the biomimetic finger and the grasped object, thereby changing the friction force between them, solving the technical problem that the friction force of existing biomimetic fingers cannot be adjusted.

### DESCRIPTION OF DRAWINGS

In order to more clearly illustrate the technical solutions in the embodiments of the present application, the drawings needed in the description of the embodiments or the prior art will be briefly introduced below. Obviously, the drawings described below are only some embodiments of the present application, and those skilled in the art can obtain other drawings based on these drawings without creative effort.

FIG. 1 is a structural schematic diagram of a biomimetic finger provided in an embodiment of the present application;

FIG. 2 is a physical image of a biomimetic finger provided in an embodiment;

FIG. 3 is a physical image of an epidermis of a biomimetic finger provided in an embodiment;

FIG. 4 is a 20× magnified physical image of a local area of an epidermis of a biomimetic finger provided in an embodiment;

FIG. 5 is a 50× magnified physical image of a local area of an epidermis of a biomimetic finger provided in an embodiment;

FIG. 6 is a structural schematic diagram of a rigid support member of a biomimetic finger provided in an embodiment;

FIG. 7 is another structural schematic diagram of a rigid support member of a biomimetic finger provided in an embodiment;

FIG. 8 is a physical image of a rigid support member of a biomimetic finger provided in an embodiment;

FIG. 9 is another physical image of a rigid support member of a biomimetic finger provided in an embodiment;

FIG. 10 is a test graph of an average friction force of a dry human finger;

FIG. 11 is a test graph of an average friction force of a dry biomimetic finger;

FIG. 12 is a test graph of an average friction force of a semi-dry human finger;

FIG. 13 is a test graph of an average friction force of a wet human finger;

FIG. 14 is test results of an average friction force of a dry human finger on a glass surface;

FIG. 15 is test results of an average friction force of a biomimetic finger on a glass surface under different water flow rates supplied by an injection pump;

FIG. 16 is test results of an average friction force of the biomimetic finger as a function of the injected water volume;

FIG. 17 is test results of an average friction force of a dry human finger on a leather material;

FIG. 18 is test results of an average friction force of a dry biomimetic finger on a leather material;

FIG. 19 is test results of an average friction force of a biomimetic finger on a leather material under different water supply volumes from an injection pump;

FIG. 20 is test results of an average friction coefficient of a biomimetic finger on a leather material under different water supply volumes from an injection pump;

FIG. 21 is a schematic diagram of a gripper provided in an embodiment;

FIG. 22 is a schematic diagram of a manufacturing method of a biomimetic finger provided in an embodiment;

FIG. 23 is a schematic diagram of a process for providing an epidermis in a manufacturing method provided in an embodiment;

FIG. 24 is a physical image of a molding mold provided in an embodiment;

FIG. 25 is a physical image of a punching component placed on a molding mold in an embodiment; and

FIG. 26 is a physical image of a punching component provided in an embodiment.

In the Drawings, the reference signs are listed as following:
10—biomimetic finger; 20—gripper; 21—closing and opening driving member; 30—molding mold; 31—molding groove; 40—punching component; 41—first micro—needle; 42—roller; 43—handle; 100—epidermis; 110—first liquid outlet hole; 120—patterned groove; 130—mounting groove; 200—elastomer; 210—second liquid outlet hole; 300—rigid support; 310—support groove; 311—first supporting surface; 312—second supporting surface; 313—third supporting surface; 320—rigid support planar surface; 330—rigid support curved surface; 331—cylindrical curved surface; 332—spherical curved surface; 400—liquid delivery tube; 401—first end; 402—second end; 410—third liquid outlet hole; and 500—rigid sheet.

### DETAILED DESCRIPTION OF EMBODIMENTS

The embodiments of the present application are described in detail below, and examples of these embodiments are shown in the accompanying drawings, where the same or similar reference numerals throughout the drawings indicate the same or similar elements or elements with the same or similar functions. The embodiments described below with reference to the drawings are exemplary and intended to explain the present application, and should not be construed as limiting the present application.

Throughout this specification, references to “one embodiment” or “an embodiment” mean that a particular feature, structure, or characteristic described in connection with the embodiment is included in at least one embodiment of the present application. Thus, the phrases “in one embodiment” or “in some embodiments” appearing in various places throughout the specification are not necessarily all referring to the same embodiment. Furthermore, the particular features, structures, or characteristics may be combined in any suitable manner in one or more embodiments.

In the description of the present application, it should be understood that the terms “length”, “width”, “upper”, “lower”, “front”, “rear”, “left”, “right”, “vertical”, “horizontal”, “top”, “bottom”, “inner”, “outer”, etc., indicate orientations or positional relationships based on the orientations or positional relationships shown in the drawings, and are only for convenience of describing and simplifying the description of the present application, and do not indicate or imply that the device or element referred to must have a specific orientation or be constructed and operated in a specific orientation, and therefore should not be construed as limiting the present application.

Furthermore, the terms “first” and “second” are used for descriptive purposes only and should not be construed as indicating or implying relative importance or implicitly indicating the number of technical features indicated. Thus, features defined with “first” and “second” may explicitly or implicitly include one or more of these features.

In the present application, unless otherwise explicitly specified and defined, the terms “install”, “connect”, “attach”, “fix”, etc., should be broadly understood. For example, it can be a fixed connection, a detachable connection, or an integral connection; it can be a mechanical connection or an electrical connection; it can be a direct connection or an indirect connection through an intermediate medium; it can be an internal connection between two elements or an interaction relationship between two elements. For those skilled in the art, the specific meaning of the above terms in the present application can be understood according to the specific circumstances.

### Embodiment 1

Addressing the technical problem of the inability to adjust the friction force when existing biomimetic fingers grasp objects, the present application has conducted an in-depth analysis of the tribological mechanism of the biomimetic finger.

Referring to equation (1), according to Amontons' law of friction, the friction force F_{f} between the contact surfaces of two objects is linearly proportional to the applied load N and also linearly proportional to the roughness of the contact surface, expressed by the coefficient μ̅ of friction.

$${F}_{f} = \overline{μ} N \qquad ( 1 )$$

However, Amontons' law of friction is suitable for macroscopic friction and not for calculating the friction force at the nanoscale contact of the biomimetic finger. According to the Bowden-tabor law of friction, the friction force is proportional to the actual contact area. At the same time, the friction force is also related to the shear strength of the lubricating film between the contact surfaces of the two objects, especially in the boundary lubrication state, where the shear strength of the lubricating film has a significant impact on the friction force. Furthermore, human fingers sweat in real-world conditions, meaning there is a lubricating film between the human finger and the grasped object. Therefore, the inventors plan to adjust the friction force by changing the lubrication state between the biomimetic finger and the grasped object, which is more consistent with the actual friction force of a human finger.

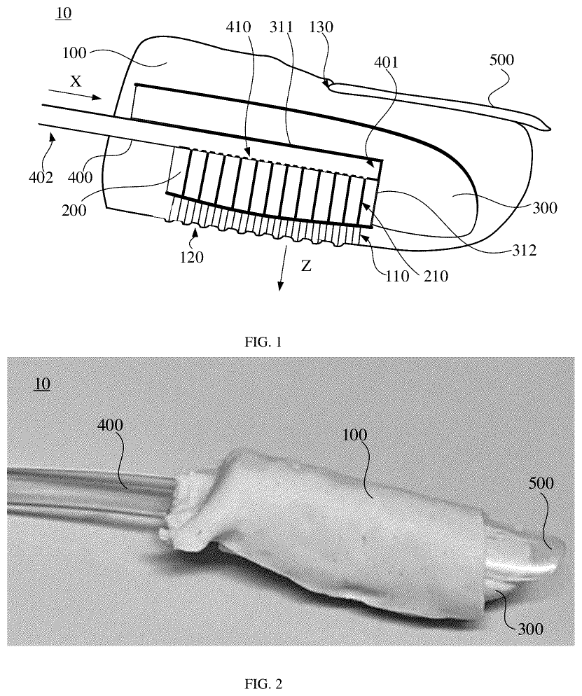

As shown in FIG. 1, the biomimetic finger 10 provided in the present application includes an epidermis 100, an elastomer 200, a rigid support member 300, and a liquid delivery tube 400. The epidermis 100 is provided with a first liquid outlet hole 110. The elastomer 200 is wrapped and mounted within the epidermis 100. The elastomer 200 is provided with a second liquid outlet hole 210, which is communicated with the first liquid outlet hole 110. The rigid support member 300 is wrapped and mounted within the epidermis 100. The first end 401 of the liquid delivery tube 400 is wrapped and mounted within the epidermis 100. The first end 401 of the liquid delivery tube 400 is supported between the rigid support member 300 and the elastomer 200. The side of the first end 401 of the liquid delivery tube 400 is provided with a third liquid outlet hole 410, which is communicated with the second liquid outlet hole 210. The second end 402 of the liquid delivery tube 400 extends to the outside of the epidermis 100.

In the embodiment, when the epidermis 100 of the biomimetic finger 10 contacts the grasped object, liquid can flow from the second end 402 of the liquid delivery tube 400 located outside the epidermis 100 to the first end 401 of the liquid delivery tube 400 located inside the epidermis 100, sequentially passing through the third liquid outlet hole 410, the second liquid outlet hole 210, and the first liquid outlet hole 110 to reach the space between the epidermis 100 and the grasped object. This changes the lubrication state and friction coefficient between the biomimetic finger 10 and the grasped object, thereby adjusting the frictional force between the biomimetic finger 10 and the grasped object.

In the embodiment, the liquid can be a polar or non-polar liquid such as artificial sweat, pure water, saline solution, or oil, or a mixture of two or more liquids. The specific type of liquid is not limited here. The liquid can be introduced into the liquid delivery tube 400 by a power pump. For example, a syringe pump can be used to deliver a constant and controllable amount of liquid to the liquid delivery tube 400. The syringe pump includes a reservoir and a movable piston; the reservoir stores the liquid, and the movable piston controls the liquid delivery.

FIG. 2 shows a physical diagram of the biomimetic finger 10 provided in this embodiment. The epidermis 100 is equivalent to the skin of the biomimetic finger 10, the elastomer is equivalent to the tissue of the biomimetic finger 10, the rigid support member 300 is equivalent to the bone of the biomimetic finger 10, and the liquid delivery tube 400 is equivalent to the blood vessel of the biomimetic finger 10. The epidermis 100 encloses the elastomer 200, the rigid support member 300, and the liquid delivery tube 400. The second end 402 of the liquid delivery tube 400 is exposed outside the epidermis 100 for the injection of external liquid. The rigid support member 300 can be completely enclosed within the epidermis 100, or partially exposed outside the epidermis 100.

The biomimetic finger 10 provided in the embodiment can simulate the sweating of a human finger and can be applied in various scenarios to achieve various purposes. In some scenarios, the biomimetic finger 10 can control the frictional force through liquid discharge, enabling reliable grasping. For example, by controlling friction, objects of different types, stiffnesses, and sizes can be grasped without damaging the grasped object due to excessive friction or causing it to slip due to insufficient friction. In some scenarios, due to the different friction coefficients between the biomimetic finger 10 and different types of grasped objects under the same lubrication conditions, the biomimetic finger 10 can measure the friction coefficient with the grasped object by dispensing liquid, thereby achieving surface identification of the grasped object. In some scenarios, the biomimetic finger 10 can simulate sweating, more realistically mimicking the actual behavior of a human finger, and can be used in place of a human finger for scientific research or simulating human behaviors such as touch.

In some embodiments, the epidermis 100 encloses the elastomer 200, the rigid support member 300, and the liquid delivery tube 400. The epidermis 100 is folded to form a sleeve.

In some embodiments, the main material of the epidermis 100 includes at least one of a silicone, a polyurethane, an acrylate, a natural rubber, a silicone rubber, a fluorinated silicone rubber, a styrene-based thermoplastic elastomer, and a latex. That is, the epidermis 100 can be composed of one or more of the silicone, the polyurethane, the acrylate, and the latex, or it can be composed of one or more of the silicone, the polyurethane, the acrylate, and the latex, as well as other auxiliary materials. The auxiliary materials can be colored pigments, allowing the epidermis 100 to display different skin tones. The combined mass of the silicone, the polyurethane, the acrylate, and the latex accounts for more than 50% of the mass of the epidermis 100.

Specifically, the main material of the epidermis 100 is the silicone. First, the silicone is an inorganic-organic polymer containing Si, O, C, and H, as well as other secondary elements. Silicone resin alone has a refractive index and color similar to skin, and the refractive index and color can be further adjusted by combining it with other substances and different material structures. Second, the silicone also allows for surface regeneration, producing the surface morphology of finger skin. Third, models based on silicone resin can be used to simulate various characteristics and have the characteristics of easy processing and preparation, non-toxicity, and long-term stability. From a materials science perspective, the skin of a real finger is a very complex active open system, composed of highly non-uniform and anisotropic composite materials. The skin also actively exchanges mass and heat with the body and the environment. Therefore, using the silicone as the main material to prepare the epidermis 100 allows for the achievement of characteristics similar to finger skin.

Specifically, the main material of the epidermis 100 is the polyurethane. Since the polyurethane is a highly malleable material, it can be made into a model with a skin-like texture and elasticity, which can effectively simulate the finger skin.

Specifically, the main material of the epidermis 100 is the acrylate. The acrylate is a transparent material that can be mixed with flexible materials to create a soft, skin-like epidermis 100. The transparent epidermis 100 allows for easy observation of the internal operation of the biomimetic finger 10 by the operator.

Specifically, the main material of the epidermis 100 is the latex. The latex has the characteristics of softness, good elasticity, and transparency, making it suitable for preparing simulated skin.

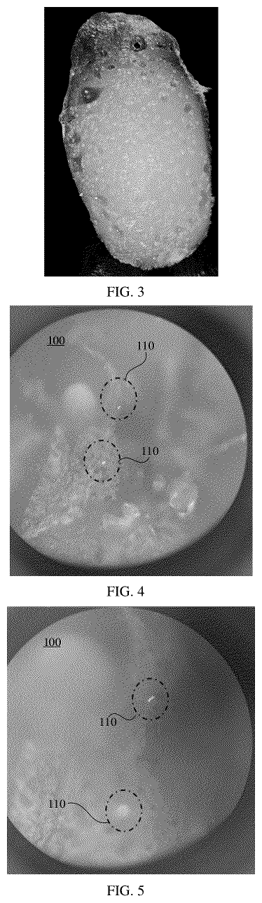

FIG. 3 shows the epidermis 100 made by the inventor using silicone as the main material. It is soft, elastic, and has micro-pores (i.e., the first liquid outlet holes 110), which can simulate human skin. FIG. 4 is a 20× magnified physical image of a local area of the epidermis 100, and FIG. 5 is a 50× magnified physical image of a local area of the epidermis 100, showing the first liquid outlet holes 110 in the dashed circle. The inventor confirmed that water can pass through the first liquid outlet holes 110 by dripping water onto the epidermis 100 using a dropper, which created sufficient pressure for the water to drip through. Without pressure, the water could not pass through the first liquid outlet holes 110. The high surface tension of the epidermis 100 was identified as the reason for this phenomenon, confirming the expected result: the liquid outlet function can be controlled by applying water pressure.

In this embodiment, the number of first liquid outlet holes 110 can be one or more than two. The first liquid outlet holes 110 can be distributed at various positions on the epidermis 100, or on the side of the epidermis 100 that comes into contact with the grasped object. The first liquid outlet holes 110 can be naturally formed during the material molding process, or they can be artificially created by puncturing with the first micro-needle 41 described below.

In one embodiment, as shown in FIG. 1, the number of first liquid outlet holes 110 is greater than 3, so as to increase the liquid outlet area of the epidermis 100 and increase the maximum liquid output, allowing the biomimetic finger 10 to control the liquid output rate over a wider range and enabling a wider range of applications.

Multiple first liquid outlet holes 110 can be distributed on the epidermis 100 at predetermined intervals according to a preset pattern. For example, multiple first liquid outlet holes 110 are arranged in a rectangular array, a circular array, or a zigzag pattern. For example, multiple first liquid outlet holes 110 are arranged in the shape of a fingerprint, forming multiple successively nested circles.

In one embodiment, as shown in FIG. 1, the depth direction of the first liquid outlet hole 110 is substantially perpendicular to the length direction X of the liquid delivery tube 400. In other words, the angle between the depth direction of the first liquid outlet hole 110 and the length direction X of the liquid delivery tube 400 can be 80° to 100°. When there are multiple first liquid outlet holes 110, the depth directions of the multiple first liquid outlet holes 110 can all be the same, or they may not all be the same.

Specifically, in the cross-section of the biomimetic finger 10 shown in FIG. 1, the depth direction of the first liquid outlet hole 110 is the same as the radial direction Z of the liquid delivery tube 400, and the radial direction Z is perpendicular to the length direction X. Multiple first liquid outlet holes 110 are distributed along the length direction X at intervals to achieve uniform liquid output and uniform distribution of friction between the biomimetic finger 10 and the grasped object.

In one embodiment, the diameter of the first liquid outlet hole 110 is 40 μm to 1000 μm, so that the first liquid outlet hole 110 has the characteristics of a capillary tube, which can create Laplace pressure between the biomimetic finger 10 and the grasped object, causing them to attract each other and enabling the grasping action.

Optionally, the diameter of the first liquid outlet hole 110 is 40 μm, 60 μm, 100 μm, 500 μm, or 1000 μm.

It is understood that in other embodiments, the diameter of the first liquid outlet hole 110 can also be 30 μm, 1100 μm, or 1200 μm.

In one embodiment, the epidermis 100 is embedded with conductive particles, and the epidermis 100 has the conductivity of human skin, which can be used for identification in charged environments, etc.

In the preparation of the epidermis 100, conductive particles can be added as auxiliary materials to the main material of the epidermis 100.

Optionally, the conductive particles are Carbon Nanotube (CNT) particles, which have high flexibility, conductivity, and thermal conductivity, and can enhance the strength and rigidity of the epidermis 100, and the conductive and thermal performance of the epidermis 100 are improved. It is understood that in other embodiments, the conductive particles can also be particles made of conductive materials such as graphene particles, silver nanowires, copper powder particles, silver powder particles, iron powder particles, etc.

In one embodiment, as shown in FIG. 1, the outer surface of the epidermis 100 is provided with patterned grooves 120, and the end of the first liquid outlet hole 110 is communicated with the patterned grooves 120. The liquid enters the patterned grooves 120 after passing through the first liquid outlet hole 110 and comes into contact with the grasped object. The patterned grooves 120 can increase the contact area of the liquid and improve the uniformity of the friction force.

Specifically, the patterned grooves 120 are in the shape of fingerprints, forming multiple successively nested circles, which can more realistically simulate the behavior of a finger grasping or touching an object. It is understood that in other embodiments, the shape of the patterned grooves 120 can also be geometric shapes, animal shapes, or bird shapes, etc., which is not limited herein.

In some embodiments, the main material of the elastomer 200 includes at least one of sponge, thermoplastic rubber, and thermoplastic vulcanized rubber, which can simulate the elasticity of tissue, enabling the biomimetic finger 10 to elastically touch or grasp objects. These materials are also easily formed into a porous structure, allowing for the creation of the second liquid outlet holes 210. The elastomer 200 can be composed of one or more of the sponge, the thermoplastic rubber, and the thermoplastic vulcanized rubber, or it can be composed of one or more of these materials along with other auxiliary materials. The combined mass of the sponge, the thermoplastic rubber, and the thermoplastic vulcanized rubber accounts for more than 50% of the total mass of the elastomer 200.

Specifically, the main material of the elastomer 200 is the polyurethane sponge. The polyurethane sponge can have a density of 0.09 g/cm⁻³, has a porous structure that allows liquid to pass through, and has a Young's modulus E similar to that of finger tissue. The Young's modulus of finger tissue is approximately 0.04 MPa, while the Young's modulus of 0.09 g/cm⁻³ polyurethane sponge is approximately 0.08 MPa.

In this embodiment, the number of second liquid outlet holes 210 can be one or more than two. The second liquid outlet holes 210 can be distributed at various locations on the elastomer 200, or they can be distributed on the side of the elastomer 200 that contacts the epidermis 100. The second liquid outlet holes 210 can be formed naturally during the material molding process, or they can be artificially created using the second micro-needles described below.

In some embodiments, as shown in FIG. 1, the diameter of the second liquid outlet holes 210 is larger than the diameter of the first liquid outlet holes 110 to facilitate the smooth flow of liquid.

In some embodiments, the diameter of the second liquid outlet hole 210 is 1 μm to 1000 μm, so that the second liquid outlet hole 210 has capillary characteristics. The liquid can be adsorbed within the second liquid outlet hole 210, preventing it from directly impacting the epidermis 100 due to an excessively large diameter, and also preventing difficulty in liquid outflow from the epidermis 100 due to an excessively small diameter.

Optionally, the diameter of the second liquid outlet hole 210 is 1 μm, 50 μm, 100 μm, 300 μm, 500 μm, or 1000 μm. It is understood that in other embodiments, the diameter of the second liquid outlet hole 210 may also be 1100 μm or 1200 μm.

In one embodiment, as shown in FIG. 1, the number of second liquid outlet holes 210 is greater than 3 to increase the maximum liquid output and ensure liquid supply to the epidermis 100.

In one embodiment, as shown in FIG. 1, the depth direction of the second liquid outlet hole 210 is approximately perpendicular to the length direction X of the liquid delivery tube 400. In other words, the angle between the depth direction of the second liquid outlet hole 210 and the length direction X of the liquid delivery tube 400 can be 80° to 100°. When there are multiple second liquid outlet holes 210, the depth directions of the multiple second liquid outlet holes 210 may all be the same, or they may not all be the same.

Specifically, in the cross-section of the biomimetic finger 10 shown in FIG. 1, the depth direction of the second liquid outlet hole 210 is the same as the radial direction Z of the liquid delivery tube 400. Multiple second liquid outlet holes 210 are distributed along the length direction X, achieving uniform liquid supply to the first liquid outlet hole 110, so that the hydraulic pressure on the epidermis 100 is uniform, and the outer surface shape of the flexible epidermis 100 remains relatively stable.

In one embodiment, as shown in FIG. 1, there is a gap between the second liquid outlet hole 210 and the first liquid outlet hole 110, and the gap forms a buffer. The liquid passing through the second liquid outlet hole 210 does not directly flow towards the first liquid outlet hole 110, but instead flows along the inner surface of the epidermis 100 into the first liquid outlet hole 110.

In one embodiment, the surface of the elastomer 200 refers to both the inner and outer surfaces. The surface of the elastomer 200 includes a hydrophobic surface and a hydrophilic surface. For example, the hydrophobic surface is provided with a hydrophobic layer to prevent the liquid from easily wetting the hydrophobic surface. The pore wall of the second liquid outlet hole 210 is located on the hydrophilic surface. Liquid falling on the elastomer 200 can be guided to flow towards the hydrophilic surface, and the second liquid outlet hole 210 located on the hydrophilic surface can absorb the liquid and guide the liquid through the hydrophobic surface to the epidermis 100. Thus, the arrangement of the hydrophobic surface allows the liquid on the elastomer 200 to flow directly into the second liquid outlet hole 210, so as to control the flow and mix of the liquid, and also prevent non-specific cell adhesion.

Specifically, the elastomer 200 is soaked with a hydrophobic agent on the surface near the epidermis 100 to maintain its texture and reduce the water absorption rate of the elastomer 200. The second micro-needle is inserted into the second liquid outlet hole 210, so that the elastomer 200 forms a hydrophobic surface and a hydrophilic surface, and the pore wall of the second liquid outlet hole 210 belongs to the hydrophilic surface. Optionally, the hydrophobic agent is Poly dimethyl siloxane (PDMS). Due to the presence of methyl groups and siloxane bonds in the molecular structure of PDMS, its surface has a low surface energy, causing water molecules to form spherical droplets on its surface instead of spreading out.

It can be understood that in other embodiments, the hydrophobic surface can also be made using silicone-based pressure-sensitive adhesive.

In this embodiment, the number of third liquid outlet holes 410 can be one or more than two. The third liquid outlet holes 410 can be distributed at various positions on the liquid delivery tube 400, or on the side of the liquid delivery tube 400 that contacts the elastomer 200. The third liquid outlet holes 410 can be directly formed during the molding process or obtained through subsequent processing.

In one embodiment, as shown in FIG. 1, the diameter of the third liquid outlet hole 410 is larger than the diameter of the second liquid outlet hole 210 to facilitate smooth liquid flow.

In one embodiment, the inner diameter of the liquid delivery tube 400 is 1 mm to 10 mm, avoiding an inner diameter that is too small, which would make it difficult to inject liquid, and also avoiding an inner diameter that is too large, which would lead to excessive liquid supply and over-lubrication, thus reducing friction.

It is understood that, in order to enhance friction, the liquid output of the first liquid outlet hole 110 is controlled to 0.0005 mL. This can be achieved by controlling at least one of the diameter and number of the first liquid outlet hole 110, the diameter and number of the second liquid outlet hole 210, the diameter and number of the third liquid outlet hole 410, and the inner diameter of the liquid delivery tube 400.

In one embodiment, the number of third liquid outlet holes 410 is greater than 3 to increase the maximum liquid output and ensure liquid supply to the elastomer 200.

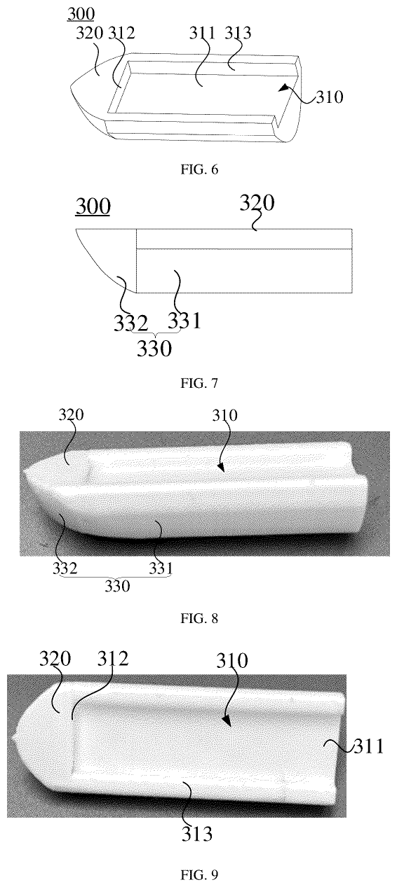

In one embodiment, as shown in FIGS. 6 and 7, the main material of the rigid support member 300 includes at least one of a plastic, a steel, a copper, an aluminum alloy, and a nickel-titanium alloy. These materials have good rigidity and strength and can support the biomimetic finger 10, acting as a skeleton. The rigid support member 300 can be composed of one or more of the plastic, the steel, the copper, the aluminum alloy, and the nickel-titanium alloy; the rigid support member 300 can be composed of one or more of the plastic, the steel, the copper, the aluminum alloy, and the nickel-titanium alloy, as well as other auxiliary materials. The combined weight of the plastic, the steel, the copper, the aluminum alloy, and the nickel-titanium alloy accounts for more than 50% of the weight of the rigid support member 300.

Specifically, at least one of the plastic, the steel, the copper, the aluminum alloy, and the nickel-titanium alloy is used to manufacture the rigid support member 300 through additive manufacturing, injection molding, or casting. The additive manufacturing can create complex designs, especially bone shapes that are difficult to produce using traditional manufacturing methods, and can be easily modified and customized to meet specific design requirements. In addition, the additive manufacturing can create multiple iterations of a product within hours, allowing for rapid prototyping in a more cost-effective manner.

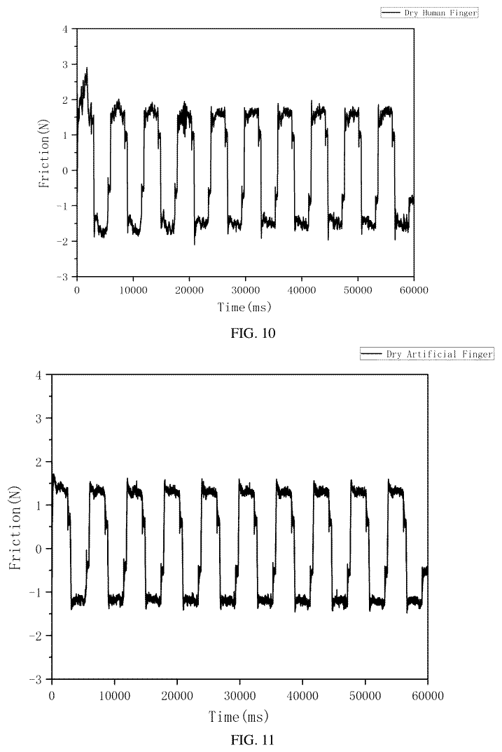

FIGS. 8 and 9 show physical images of the rigid support member 300 fabricated using additive manufacturing.

In one embodiment, as shown in FIGS. 1, 6 to 9, a side of the rigid support member 300 is provided with a first supporting surface 311 and a second supporting surface 312. The first supporting surface 311 and the second supporting surface 312 are connected approximately perpendicular to each other. The first supporting surface 311 faces the first liquid outlet hole 110. The side of the liquid delivery tube 400 away from the elastomer 200 is supported by the first supporting surface 311, and the end of the first end 401 of the liquid delivery tube 400 and the end of the elastomer 200 are abutted against the second supporting surface 312. Thus, the first supporting surface 311 provides support for the liquid delivery tube 400, and the second supporting surface 312 provides support for both the liquid delivery tube 400 and the elastomer 200, thereby ensuring that the positions of the various components of the biomimetic finger 10 remain relatively stable and do not shift.

Specifically, the angle between the first supporting surface 311 and the second supporting surface 312 is 80° to 100°.

Specifically, the first supporting surface 311 is a flat surface, capable of providing stable support. Similarly, the second supporting surface 312 is a flat surface.

Specifically, as shown in FIGS. 6 and 7, one side of the rigid support member 300 is provided with a support groove 310. The bottom of the support groove 310 forms the first supporting surface 311, and the groove wall at one end of the support groove 310 forms the second supporting surface 312. The liquid delivery tube 400 and the elastomer 200 are mounted within the support groove 310 to ensure their stable position.

Optionally, the support groove 310 is further provided with two opposing third supporting surfaces 313, which are approximately perpendicular to the second supporting surface 312. The opposite sides of the elastomer 200 abut against the two third supporting surfaces 313.

Optionally, the rigid support member 300 is provided with a rigid support planar surface 320 on one side of the support groove 310. The elastomer 200 is located within the support groove 310, meaning the rigid support planar surface 320 faces the object. The rigid support planar surface 320 provides rigid planar support, allowing the epidermis 100 to make contact with the object's basic plane, improving grasping and touching effects.

Optionally, the rigid support member 300 is provided with a rigid support curved surface 330 on the side away from the support groove 310. The rigid support curved surface 330 makes the back of the biomimetic finger 10 smooth, preventing interference and scratching with other objects. Furthermore, the rigid support curved surface 330 includes a cylindrical curved surface 331 and a spherical curved surface 332 connected sequentially along the length direction of the liquid delivery tube 400. The cylindrical curved surface 331 is positioned opposite the support groove 310, increasing the thickness of the rigid support member 300 corresponding to the support groove 310, and improving the support force on the elastomer 200. The spherical curved surface 332 is located on the side of the cylindrical curved surface 331 away from the second end 402 of the liquid delivery tube 400. The spherical curved surface 332 causes the thickness of the rigid support member 300 to gradually decrease, so that the end of the rigid support member 300 is smooth.

Optionally, the edge of the rigid support curved surface 330 can be directly connected to the edge of the rigid support planar surface 320, or it can be connected to the rigid support planar surface 320 through other side surfaces.

In one embodiment, as shown in FIG. 1, the biomimetic finger 10 further includes a rigid sheet 500. One end of the rigid sheet 500 is mounted on the outer surface of the epidermis 100, and the other end of the rigid sheet 500 extends to the outside of the epidermis 100 and is spaced apart from the epidermis 100. In other words, the other end of the rigid sheet 500 protrudes from the epidermis 100, allowing the biomimetic finger 10 to perform complex actions such as scraping, picking, and scratching.

Specifically, as shown in FIG. 1, the rigid sheet 500 and the first liquid outlet hole 110 are located on opposite sides of the epidermis 100, which maximizes the distance between the rigid sheet 500 and the first liquid outlet hole 110. This allows the biomimetic finger 10 to perform grasping or touching actions using liquid ejection and scraping actions using the rigid sheet 500 relatively independently, without mutual interference.

It can be understood that in other embodiments, the rigid sheet 500 and the first liquid outlet hole 110 may be located on the same side of the epidermis 100, or on adjacent sides of the epidermis 100; which is not specifically limited herein.

Specifically, as shown in FIG. 1, the end of the rigid sheet 500 located outside the epidermis 100 and the second end 402 of the liquid delivery tube 400 are located on opposite ends of the epidermis 100. The rigid sheet 500 and the second end 402 of the liquid delivery tube 400 are located at opposite ends of the epidermis 100 in the length direction X, which maximizes the distance between the rigid sheet 500 and the second end 402 of the liquid delivery tube 400, so that they are relatively independent and do not interfere with each other.

It is understood that, in other embodiments, the rigid sheet 500 can be located on the same end of the epidermis 100 as the second end 402 of the liquid delivery tube 400, or the rigid sheet 500 can be located in the middle of the epidermis 100, and which is not specifically limited herein.

Specifically, as shown in FIG. 1, the outer surface of the epidermis 100 is provided with a mounting groove 130, and one end of the rigid sheet 500 is mounted in the mounting groove 130. The provision of the mounting groove 130 facilitates the positioning and stable mounting of the rigid sheet 500.

It is understood that the epidermis 100 may also not provide with a mounting groove 130, and the rigid sheet 500 is directly mounted on the outer surface of the epidermis 100, or the outer surface of the epidermis 100 is provided with a mounting bracket for the rigid sheet 500.

Specifically, the side of the rigid sheet 500 close to the epidermis 100 can be in contact with the surface of the rigid support member 300, so that even if the epidermis 100 is between the rigid sheet 500 and the rigid support member 300, the rigid sheet 500 still receives support from the rigid support member 300, and the support area is large.

It is understood that the rigid sheet 500 is equivalent to the fingernail of the biomimetic finger 10.

In some embodiments, as shown in FIG. 1, the elastomer 200 can be mounted in the epidermis 100 by bonding, welding, sleeve fitting, or abutting. The rigid support member 300 can be mounted in the epidermis 100 by bonding, welding, sleeve fitting, or abutting. The rigid support member 300 and the elastomer 200 can be fixed by bonding, welding, snapping, fastener connection, or abutting.

The liquid delivery tube 400 can be mounted in the epidermis 100 by bonding, welding, sleeve fitting, or abutting. The liquid delivery tube 400 and the rigid support member 300 can be fixed by bonding, welding, snapping, sleeve fitting, plugging, fastener connection, or abutting. The liquid delivery tube 400 and the elastomer 200 can be fixed by bonding, welding, snapping, sleeve fitting, fastener connection, or abutting. The rigid sheet 500 and the epidermis 100 can be fixed together by bonding, welding, or fasteners.

In some embodiments, the main material of the epidermis 100 is a silicone, the main material of the elastomer 200 is a polyurethane foam, and the material of the rigid support 300 is an ABS plastic, formed integrally using the additive manufacturing. In order to verify the similarity between the biomimetic finger 10 and a human finger, the experimental equipment included: an injection pump connected to the second end 402 of the liquid delivery tube 400, the injection pump is used to supply pure water; and a tribometer. The injection pump is set to an injection rate of 0.5 mL/min, and the tribometer includes a horizontally movable platform and a sensor mounted below the platform. The sensor is used to record the friction force at 1000 Hz, the ambient temperature is 22.7° C., the air humidity is 60%, the applied pressure is 0.5 N, and the duration of each test is 60 s. The average friction force refers to the average of the friction forces from 10 repeated tests.

FIG. 10 shows the average friction force of a dry human finger, and FIG. 11 shows the average friction force of the dry biomimetic finger 10. Comparing FIGS. 10 and 11, it can be seen that under the same conditions, the friction force of the dry biomimetic finger 10 is similar to that of a dry human finger, proving that the friction performance of the biomimetic finger 10 provided in the embodiment is close to that of a human finger.

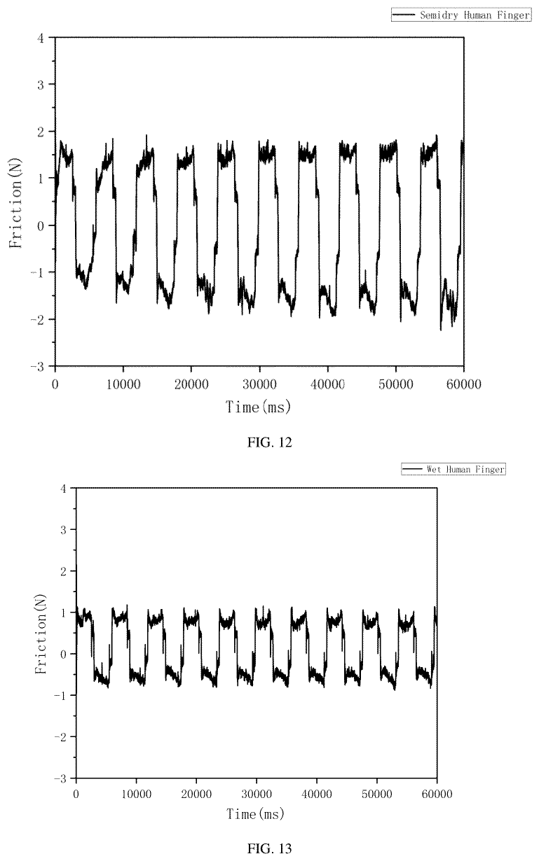

FIG. 12 shows the average friction force of a semi-dry human finger, and FIG. 13 shows the average friction force of a wet human finger. Comparing FIGS. 10, 12, and 13, it can be seen that the friction mode of a human finger differs depending on the amount of water on the surface of the human finger. The friction force of a semi-dry human finger is the highest, followed by that of a dry human finger, while the friction force of a wet human finger is the lowest. The semi-dry human finger refers to a finger that is partially wet but not saturated.

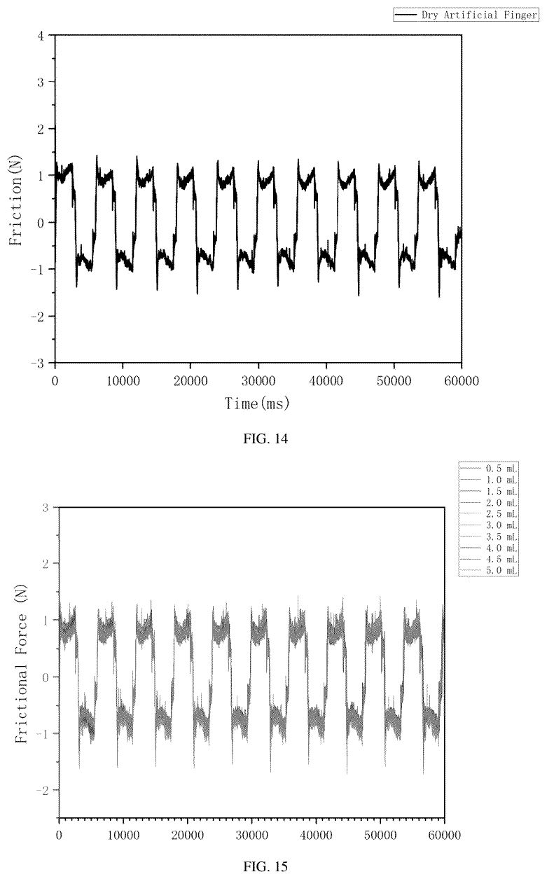

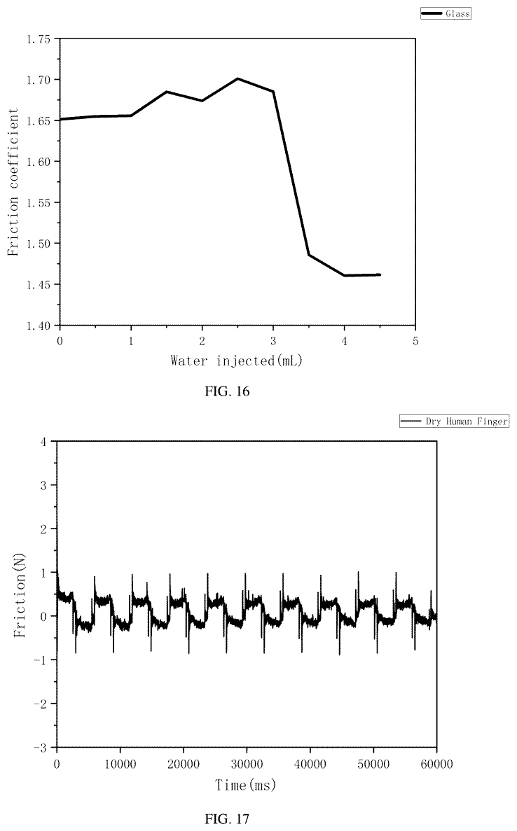

FIG. 14 shows the average friction force of a dry human finger on a glass surface, and FIG. 15 shows the average friction force of the biomimetic finger 10 on a glass surface with different amounts of water supplied by the injection pump. As shown in FIG. 16, the average friction force of the biomimetic finger 10 changes with the amount of water injected. When 0 to 2.5 mL of pure water is injected, the average friction force increased. When the injection volume is 3 mL to 3.5 mL, the average friction force decreased sharply. When the injection volume exceeded 3.5 mL, the average friction force remained stably low. This shows that the biomimetic finger 10 also exhibits higher friction in a semi-dry state, similar to the performance of a human finger, meaning that the biomimetic finger 10 can simulate the friction of a human finger on glass.

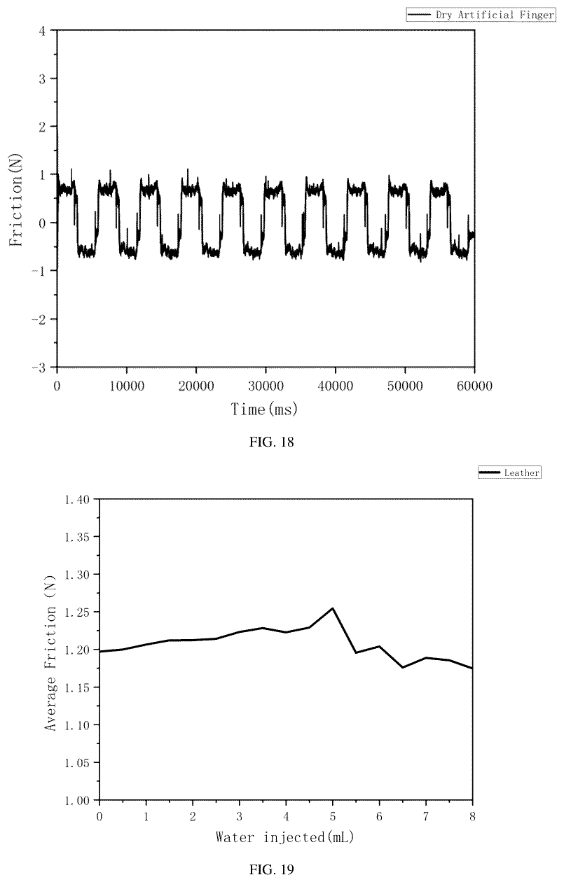

FIG. 17 shows the average friction force of a dry human finger on a leather material, and FIG. 18 shows the average friction force of a dry biomimetic finger 10 on a leather material. This shows that the friction performance of the human finger and the biomimetic finger 10 on leather material are basically the same.

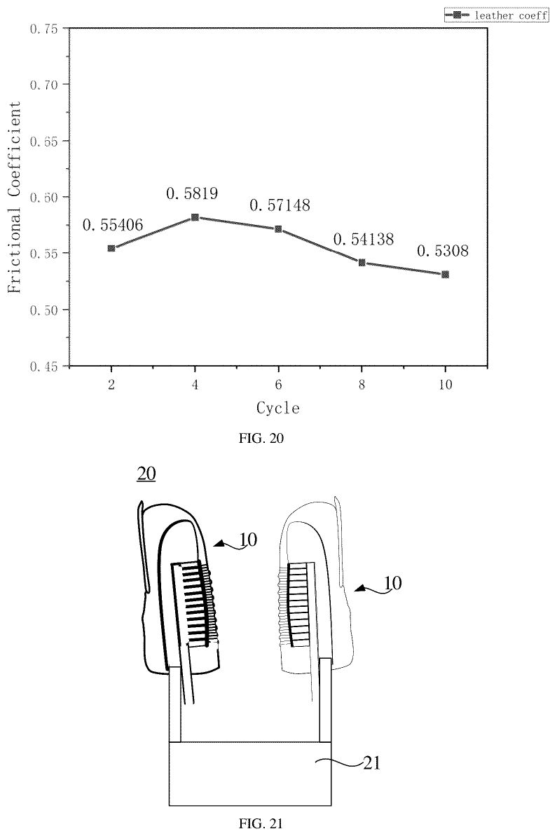

FIG. 19 shows the average friction force of the biomimetic finger 10 on leather material under different water supply volumes from the injection pump, and FIG. 20 shows the average friction coefficient of the biomimetic finger 10 on leather material under different water supply volumes from the injection pump. The friction coefficient is equal to the friction force divided by 0.5 N. FIG. 20 shows how the friction coefficient of the biomimetic finger 10 changes with the amount of injected water. When 0 to 5 mL of pure water is injected, the average friction force increased. When the injection volume exceeded 5 mL, the friction coefficient decreased. When the biomimetic finger 10 is filled with water, the decrease in friction coefficient was less than 0.01 N. Therefore, compared to the effect of sweating on glass, the effect of sweating on leather is less significant, possibly because the leather may absorb moisture from the surface of the finger skin.

This embodiment demonstrates the similarity in friction performance between the biomimetic finger 10 and a human finger, enabling the biomimetic finger 10 to realistically simulate a human finger. The friction coefficient first increases and then decreases with increasing moisture, and the friction coefficient and its changes vary for different materials, which can be used to identify different material interfaces.

### Embodiment 2

As shown in FIG. 21, the gripper 20 provided in the present application includes a closing and opening driving member 21 and at least two biomimetic fingers 10 of any type described in Example 1. The closing and opening driving member 21 is connected to the biomimetic fingers 10 to drive at least two biomimetic fingers 10 to move closer to or further away from each other, thereby achieving gripping or releasing of the grasped object.

Optionally, the gripper 20 also includes an injection pump, the outlet of the injection pump is connected to the second end 402 of the liquid delivery tube 400 for supplying liquid to the liquid delivery tube 400. The liquid can be pure water, saline solution, oil, etc. The injection pump can be a quantitative injection pump.

Specifically, the number of biomimetic fingers 10 of the gripper 20 can be two, three, four, five, or more than five, which is not limited herein. For example, if the number of biomimetic fingers 10 is five, the gripper 20 is used to simulate the human palm and perform the operational movements of the human palm.

Furthermore, the biomimetic fingers 10 of the gripper 20 can be any of the biomimetic fingers 10 described in Embodiment 1, and which will not be described in detail here.

### Embodiment 3

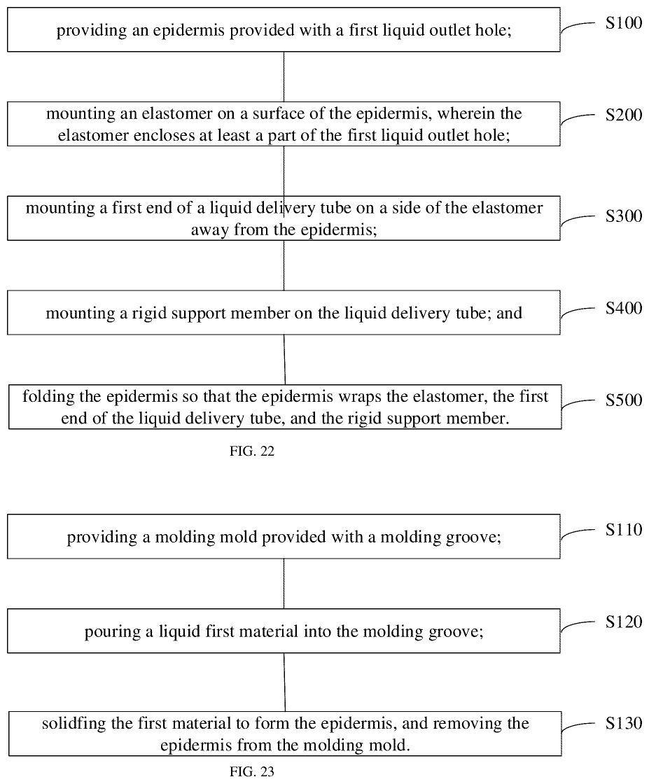

As shown in FIG. 22, the present application provides a manufacturing method of the biomimetic finger 10 in Embodiment 1, including the following steps:

In a step S100: an epidermis 100 with a first liquid outlet hole 110 is provided.

In a step S200: the elastomer 200 is mounted on one surface of the epidermis 100, and the elastomer 200 covers at least a part of the first liquid outlet hole 110.

In a step S300: the first end 401 of the liquid delivery tube 400 is mounted on the side of the elastomer 200 away from the epidermis 100, at least a part of the third liquid outlet hole 410 of the liquid delivery tube 400 faces the elastomer 200, and the second end 402 of the liquid delivery tube 400 is located outside the epidermis 100.

In a step S400: the rigid support member 300 is mounted on the liquid delivery tube 400.

In a step S500: the epidermis 100 is folded so that the epidermis 100 encloses around the elastomer 200, the first end 401 of the liquid delivery tube 400, and the rigid support member 300.

Thus, through the above steps S100 to S500, the biomimetic finger 10 in Embodiment 1 can be manufactured. In this process, when the epidermis 100 of the biomimetic finger 10 contacts the grasped object, liquid can flow from the second end 402 of the liquid delivery tube 400 located outside the epidermis 100 to the first end 401 of the liquid delivery tube 400 located inside the epidermis 100, sequentially passing through the third liquid outlet hole 410, the second liquid outlet hole 210, and the first liquid outlet hole 110 to reach the space between the epidermis 100 and the grasped object. This changes the lubrication state and friction coefficient between the biomimetic finger 10 and the grasped object, thereby adjusting the friction force between the biomimetic finger 10 and the grasped object.

In one embodiment, as shown in FIG. 23, the step S100 specifically includes:

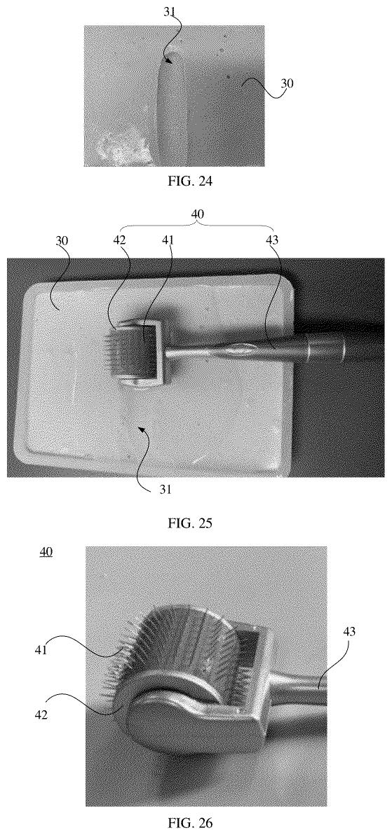

In a step S110: a molding mold 30 is provided, the molding mold 30 is provided with a molding groove 31 (see FIG. 24).

In a step S120: the liquid first material is poured into the molding groove 31, and the first material includes at least one of a silicone, a polyurethane, an acrylate, a natural rubber, a silicone gel, a fluorinated silicone rubber, a styrene-based thermoplastic elastomer, and a latex.

In a step S130: after the first material solidifies, the epidermis 100 is formed (see FIG. 3), and the epidermis 100 is removed from the molding mold 30.

The molding mold 30 allows for the rapid manufacture of the epidermis 100 with the required shape, resulting in high production efficiency and saving product iteration time.

Specifically, the step S110 includes:

In a step S111: water and alginate are placed in a molding container to form a mixture, and the mixture is stood for no more than a first preset time. Optionally, the first preset time is 45 s to 60 s.

In a step S112: the finger is pressed onto the mixture and maintaining the finger for a second preset time. Optionally, the first preset time is 3 min to 5 min.

In a step S113: the finger is separated from the mixture. The finger pressing on the mixture forms the molding groove 31, and the mixture forms the molding mold 30.

Thus, using a mixture of the water and the alginate, a molding mold 30 can be quickly formed by rapid solidification. This allows for the quick and easy manufacture of the required molding mold 30. By pressing the mixture with a human finger, a molding groove 31 identical to the human finger can be obtained, facilitating the manufacture of the epidermis 100 with the desired shape.

Optionally, before the step S111, the method also includes:

In a step S114: the amounts of water and alginate are measured. This allows for obtaining a precisely proportioned mixture, and thus an easily formable molding mold 30 is obtained.

In one embodiment, after the step S120, the above method also includes:

In a step S140: as shown in FIGS. 25 and 26, a first micro-needle 41 is used to insert into the first material. The first micro-needle 41 being inserted into the first material before the first material solidifies facilitates the deterministic creation of the first liquid outlet hole 110, and the diameter and shape of the first liquid outlet hole 110 are the same as the first micro-needle 41, meaning the formation of the first liquid outlet hole 110 is controllable.

In other embodiments, the hole formed during the molding process of the first material can be used as the first liquid outlet hole 110. In this case, the first micro-needle 41 is not needed for forming the first liquid outlet hole 110.

Optionally, the diameter of the first micro-needle 41 is 40 μm to 1000 μm.

Optionally, there are multiple first micro-needles 41, arranged along a preset pattern, thereby forming multiple first liquid outlet holes 110 arranged in a preset pattern. The preset pattern can be a rectangular array, a circular array, or a zigzag arrangement. For example, multiple first micro-needles 41 are arranged in the shape of a fingerprint, forming multiple successively nested circles.

Specifically, as shown in FIG. 25, this embodiment uses a punching component 40 to form the first liquid outlet hole 110. The punching component 40 includes a handle 43 and a first micro-needle 41 mounted on the handle 43. The operator can easily insert the first micro-needle 41 into the first material by holding the handle 43.

Optionally, the punching component 40 also includes a roller 42 rotatably mounted on the handle 43, and the first micro-needle 41 is mounted on the roller 42. In this way, the operator can quickly create multiple first liquid outlet holes 110 by rolling the roller 42. Furthermore, there are multiple first micro-needles 41, and these multiple first micro-needles 41 are spaced apart on the roller 42.

In one embodiment, before the step S120, the method further includes: In a step S150: as shown in FIGS. 25 and 26, the first micro-needle 41 is used to insert into the molding mold 30. In this way, multiple micro-holes are formed at the bottom of the molding groove 31, so that corresponding micro-holes appear on the outer surface of the prepared epidermis 100, and the first liquid outlet holes 110 are formed internally during the curing process of the first material, communicated with the micro-holes.

In one embodiment, before the step S120, the above method further includes:

In a step S160: the amount of the first material is measured. This allows for precise control of the weight and thickness of the epidermis 100.

In one embodiment, before the step S120, the method further includes:

In a step S170: the first material is mixed with a color pigment. The color pigment acts as an auxiliary material, causing the prepared epidermis 100 to display different skin tones.

In one embodiment, before the step S120, the method further includes:

In a step S180: conductive particles are scattered at the bottom of the molding groove 31. In this way, the prepared epidermis 100 is embedded with conductive particles, giving the epidermis 100 the conductivity of human skin, which can be used for identification in electrically charged environments, etc.

Optionally, the conductive particles are particles made of conductive materials such as graphene particles, silver nanowires, CNT particles, copper powder particles, silver powder particles, or iron powder particles.

In one embodiment, before the step S120, the above method further includes:

In a step S190: as shown in FIG. 1, a patterned groove 120 is created in the molding groove 31. Thus, the outer surface of the prepared epidermis 100 is provided with patterned grooves 120, and the end of the first liquid outlet hole 110 is connected to the patterned grooves 120. The liquid enters the patterned grooves 120 through the first liquid outlet hole 110 and comes into contact with the grasped object. The patterned grooves 120 can increase the contact area of the liquid and improve the uniformity of the friction force.

Optionally, the patterned grooves 120 are in the shape of fingerprints, forming multiple successively nested circles, which can more realistically simulate the behavior of fingers grasping or touching objects. Alternatively, the shape of the patterned grooves 120 can be geometric shapes, animal shapes, or bird shapes, etc., which is not limited here.

In one embodiment, before the step S200, the above method further includes the following steps:

In a step S210: a porous structure is made using a second material, the second material including at least one of a sponge, a thermoplastic rubber, and a thermoplastic vulcanized rubber.

In a step S220: the second micro-needle is inserted into the porous structure to form a second liquid outlet hole 210. Thus, the formation of the second liquid outlet hole 210 is controllable.

Optionally, the number of second micro-needles can be one or more than two. The diameter of the second micro-needle is 1 μm to 1000 μm. Further, the second micro-needle can also be mounted on the aforementioned punching component 40. It can be understood that the second liquid outlet hole 210 can also be a hole naturally formed during the molding process of the second material, and does not require piercing with a second micro-needle.

In a step S230: a side of the porous structure with the second micro-needle is immersed in a hydrophobic solution. Specifically, the side of the porous structure close to the epidermis 100 is immersed in the hydrophobic solution, and a side of the porous structure away from the epidermis 100 is not immersed in the hydrophobic solution. Further, the immersion depth of the porous structure is 10% to 60% of its thickness.

In a step S240: the porous structure is removed from the hydrophobic solution, the second micro-needle is removed, and the porous structure forms the elastomer 200. The surface of the elastomer 200 in contact with the hydrophobic solution forms a hydrophobic surface, and the hole wall of the second liquid outlet hole 210, which is not in contact with the hydrophobic solution, forms a hydrophilic surface.

Thus, one side surface of the elastomer 200 is immersed in a hydrophobic solution to maintain its texture and reduce the water absorption rate of the elastomer 200. The second micro-needle is inserted into the second liquid outlet hole 210, so that the elastomer 200 forms a hydrophobic surface and a hydrophilic surface, and the hole wall of the second liquid outlet hole 210 belongs to the hydrophilic surface. Optionally, the hydrophobic solution is polydimethylsiloxane.

Optionally, before the step S210, the method further includes:

In a step S211: the amount of the second material is measured.

In one embodiment, the main material of the rigid support member 300 includes at least one of a plastic, a steel, a copper, an aluminum alloy, and a nickel-titanium alloy.

In one embodiment, before the step S400, the above method further includes:

In a step S410: the rigid support member 300 is fabricated using the additive manufacturing technology. The additive manufacturing can create complex designs, especially bone shapes that are difficult to produce using traditional manufacturing methods, and can be easily modified and customized to meet specific design requirements. In addition, the additive manufacturing can create multiple iterations of a product within hours, allowing for rapid prototyping in a more cost-effective manner.

In one embodiment, after the step S500, the above method further includes:

In a step S600: as shown in FIG. 1, one end of the rigid sheet 500 is mounted on the outer surface of the epidermis 100, and an other end of the rigid sheet 500 extends to the outside of the epidermis 100 and is spaced apart from the epidermis 100. In other words, the another end of the rigid sheet 500 protrudes from the epidermis 100, allowing the biomimetic finger 10 to perform complex movements such as scraping, picking, and scratching.

Specifically, the rigid sheet 500 and the first liquid outlet hole 110 are located on opposite sides of the epidermis 100.

Specifically, the end of the rigid sheet 500 located outside the epidermis 100 and the second end 402 of the liquid delivery tube 400 are located on opposite ends of the epidermis 100.

Furthermore, the biomimetic finger 10 manufactured in Embodiment 3 can have any of the technical features of any of the biomimetic fingers 10 in Embodiment 1, which will not be described in detail here.

The above description merely illustrates preferred embodiments of the present application and is not intended to limit the scope of the present application. Any modifications, equivalent substitutions, and improvements made within the spirit and principles of the present application shall be included within the scope of protection of the present application.

What is claimed is:

1. A biomimetic finger, comprising:
an epidermis, provided with a first liquid outlet hole;
an elastomer, wrapped and mounted within the epidermis, wherein the elastomer is provided with a second liquid outlet hole, and the second liquid outlet hole is communicated with the first liquid outlet hole;
a rigid support member, wrapped and mounted within the epidermis; and
a liquid delivery tube, wherein a first end of the liquid delivery tube is wrapped and mounted within the epidermis, the first end of the liquid delivery tube is supported between the rigid support member and the elastomer, a side of the first end of the liquid delivery tube is provided with a third liquid outlet hole, the third liquid outlet hole is communicated with the second liquid outlet hole, and a second end of the liquid delivery tube extends to an outside of the epidermis.

2. The biomimetic finger according to claim 1, wherein the epidermis is embedded with conductive particles.

3. The biomimetic finger according to claim 1, wherein an outer surface of the epidermis is provided with patterned grooves, and an end of the first liquid outlet hole is connected to the patterned grooves.

4. The biomimetic finger according to claim 1, wherein a surface of the elastomer comprises a hydrophobic surface and a hydrophilic surface, and a hole wall of the second liquid outlet hole is located on the hydrophilic surface.

5. The biomimetic finger according to claim 1, wherein a side of the rigid support member is provided with a first supporting surface and a second supporting surface, the first supporting surface and the second supporting surface are connected approximately perpendicular to each other, the first supporting surface faces the first liquid outlet hole, a side of the liquid delivery tube away from the elastomer is supported on the first supporting surface, and an end of the first end of the liquid delivery tube and an end of the elastomer are abutted against the second supporting surface.

6. The biomimetic finger according to claim 1, wherein the biomimetic finger further comprises a rigid sheet, an end of the rigid sheet is mounted on an outer surface of the epidermis, and another end of the rigid sheet extends outside the epidermis and is spaced apart from the epidermis.

7. The biomimetic finger according to claim 6, wherein the rigid sheet and the first liquid outlet hole are located on opposite sides of the epidermis; and/or
an end of the rigid sheet located on the outer portion of the epidermis and the second end of the liquid delivery tube are located at opposite ends of the epidermis; and/or
the outer surface of the epidermis is provided with a mounting groove, and an end of the rigid sheet is mounted in the mounting groove.

8. The biomimetic finger according to claim 1, wherein the biomimetic finger further comprises at least one of follows:
a number of the first liquid outlet holes is greater than 3;
a diameter of the second liquid outlet hole ranges from 1 μm to 1000 μm;
a number of the second liquid outlet holes is greater than 3;
a gap is formed between the second liquid outlet hole and the first liquid outlet hole; and
a number of the third liquid outlet holes is greater than 3.

9. The biomimetic finger according to claim 1, wherein a main material of the epidermis comprises at least one of a silicone, a polyurethane, an acrylate, a natural rubber, a silicone gel, a fluorinated silicone rubber, a styrene-based thermoplastic elastomer, and a latex; a main material of the elastomer comprises at least one of a sponge, a thermoplastic rubber, and a thermoplastic vulcanized rubber; and a main material of the rigid support member comprises at least one of a plastic, a steel, a copper, an aluminum alloy, and a nickel-titanium alloy.

10. A gripper, comprising a closing and opening driving member and at least two biomimetic fingers according to claim 1, wherein the closing and opening driving member is connected to the at least two biomimetic fingers to drive the at least two of the biomimetic fingers to move closer to or further away from each other.

11. A manufacturing method of a biomimetic finger according to claim 1, comprising following steps:
providing an epidermis provided with a first liquid outlet hole;
mounting an elastomer on a surface of the epidermis, wherein the elastomer encloses at least a part of the first liquid outlet hole;
mounting a first end of a liquid delivery tube on a side of the elastomer away from the epidermis, and locating a second end of the liquid delivery tube outside the epidermis;
mounting a rigid support member on the liquid delivery tube; and
folding the epidermis so that the epidermis wraps the elastomer, the first end of the liquid delivery tube, and the rigid support member.

12. The manufacturing method according to claim 11, wherein the step of providing the epidermis provided with the first liquid outlet hole specifically comprises:
providing a molding mold provided with a molding groove;
pouring a liquid first material into the molding groove, wherein the first material comprises at least one of a silicone, a polyurethane, an acrylate, a natural rubber, a silicone gel, a fluorinated silicone rubber, a styrene-based thermoplastic elastomer, and a latex; and
solidfing the first material to form the epidermis, and removing the epidermis from the molding mold.

13. The manufacturing method according to claim 12, wherein the step of providing the molding mold provided with the molding groove, specifically comprises:
putting water and an alginate into a molding container to form a mixture, and standing for no more than a first preset time;
pressing a finger onto the mixture and maintaining for a second preset time; and
separating the finger from the mixture, wherein the finger pressing on the mixture forms the molding groove, and the mixture forms the molding mold.

14. The manufacturing method according to claim 12, wherein
after the step of pouring the liquid first material into the molding groove, the method further comprises: inserting a first micro-needle into the first material; and/or
before the step of pouring the liquid first material into the molding groove, the method further comprises: inserting a first micro-needle into the molding mold.

15. The manufacturing method according to claim 11, wherein before the step of mounting the elastomer on the surface of the epidermis, the method further comprises following steps:
fabricating a porous structure using a second material, wherein the second material comprises at least one of a sponge, a thermoplastic rubber, and a thermoplastic vulcanized rubber;
inserting a second micro-needle into the porous structure to form a second liquid outlet hole;
immersing a side of the porous structure with the second micro-needle in a hydrophobic solution; and
removing the porous structure from the hydrophobic solution and withdrawing the second micro-needle, wherein the porous structure forms the elastomer, a surface of the elastomer in contact with the hydrophobic solution forms a hydrophobic surface, and a hole wall of the second liquid outlet hole that is not in contact with the hydrophobic solution form a hydrophilic surface.

16. The manufacturing method according to claim 11, wherein before the step of mounting the rigid support member on the liquid delivery tube, the method further comprises: fabricating the rigid support member using an additive manufacturing technology.

17. The manufacturing method according to claim 12, wherein before the step of mounting the rigid support member on the liquid delivery tube, the method further comprises: fabricating the rigid support member using an additive manufacturing technology.

18. The manufacturing method according to claim 13, wherein before the step of mounting the rigid support member on the liquid delivery tube, the method further comprises: fabricating the rigid support member using an additive manufacturing technology.

19. The manufacturing method according to claim 14, wherein before the step of mounting the rigid support member on the liquid delivery tube, the method further comprises: fabricating the rigid support member using an additive manufacturing technology.

20. The manufacturing method according to claim 15, wherein before the step of mounting the rigid support member on the liquid delivery tube, the method further comprises: fabricating the rigid support member using an additive manufacturing technology.
